(19) United States
(12) Patent Application Publication
(10) Pub. No.: US 2025/0290543 A1
(43) Pub. Date: Sep. 18, 2025

(54) TAPERED ROLLER BEARING

(71) Applicant: NTN CORPORATION, OSAKA (JP)

(72) Inventors: Masaya MASUDA, Kuwana (JP); Taisuke IKIO, Kuwana (JP); Shouta TOHO, Kuwana (JP)

(73) Assignee: NTN CORPORATION, OSAKA (JP)

(21) Appl. No.: 19/069,439

(22) Filed: Mar. 4, 2025

(30) Foreign Application Priority Data
Mar. 12, 2024 (JP) 2024-038313

(51) Int. Cl. F16C 19/36

(52) U.S. Cl. CPC F16C 19/364

(57) ABSTRACT

A tapered roller bearing of an inner ring guide form according to the present disclosure includes a retainer including: a small-diameter-side annular part; a large-diameter-side annular part; and pillar parts which connect the small-diameter-side annular part and the large-diameter-side annular part. The following relational expression is satisfied by a small-diameter-side gap S1 which is a radial gap between the small-diameter-side annular part and a smaller collar part of an inner ring, a large-diameter-side gap S2 which is a radial gap between the large-diameter-side annular part and a larger collar part of the inner ring, an average roller diameter d of a tapered roller, a roller length 1, and an outer ring angle a. Equations, ΔS=S2 −S1 and S0=0.5 (fixed values), are established.

$$1.06 < \frac{1}{tan α} ( 1 - \frac{Δ S}{{S}_{o}} \frac{d}{ℓ} ) < 1.64$$

### CROSS REFERENCE TO THE RELATED APPLICATION

This application is based on and claims Convention priority to a Japanese patent application No. 2024-038313 filed Mar. 12, 2024, the entire disclosure of which is herein incorporated by reference as a part of this application.

### BACKGROUND OF THE INVENTION

### Field of the Invention

The present invention relates to a tapered roller bearing which can be used in a part subjected to centrifugal force such as a planetary reduction gear part of a construction machine and, in particular, a planetary part at the first stage where particularly large centrifugal force acts.

### Description of Related Art

Conventionally, in a tapered roller bearing of an inner ring guide form, guide gaps S1, S2 between both flanged parts of a retainer and an inner ring are defined by a parameter X (0.69<X<1.12). Herein, the “guide gap S1” is a radial gap between a small-diameter-side annular part of the retainer and a smaller collar part of the inner ring, and the “guide gap S2” is a radial gap between a large-diameter-side annular part of the retainer and a larger collar part of the inner ring. Thus, provided is a tapered roller bearing, in which tilting of the retainer is suppressed so that the retainer is less likely to wear (JP Laid-open Patent Publication No. 2022-042038).

FIG. 13 shows the relationship between the parameter X and the guide gap S2 in the conventional tapered roller bearing as disclosed in JP Laid-open Patent Publication No. 2022-042038. Cross marks represent the relationship between the parameter X and S2 when ΔS (a difference between S1 and S2) is not fixed. Square marks represent the relationship between the parameter X and S2 when the absolute value of ΔS is fixed to 0.15 mm. Triangle marks represent the relationship between the parameter X and S2 when the absolute value of ΔS is fixed to 0.35 mm.

In JP Laid-open Patent Publication No. 2022-042038, the parameter X is defined by the ratio of the guide gaps S1, S2. Therefore, if the absolute values of the guide gaps are reduced, the parameter X may be in regions A1, A2 which are not within the defined range R of the parameter X (0.69<X<1.12) as shown in FIG. 13. Specifically, when the absolute value of ΔS is fixed to 0.15 mm, in the region A1, the smaller the absolute values of the guide gaps S1, S2 become, the smaller the parameter X becomes. In addition, when the absolute value of ΔS is fixed to 0.35 mm, in the region A2, the smaller the absolute values of the guide gaps S1, S2 become, the larger the parameter X becomes. In a tapered roller bearing of an inner ring guide form, the smaller the absolute value ΔS of the guide gap becomes, the smaller a stress that occurs in the retainer becomes. Thus, it is important to control the absolute value of the guide gap.

### SUMMARY OF THE INVENTION

An object of the present invention is to provide a tapered roller bearing of an inner ring guide form in which whirling of a retainer can be suppressed and the bearing can be operated in a stable state.

A tapered roller bearing of an inner ring guide form according to the present invention includes:
an inner ring including a smaller collar part and a larger collar part,
an outer ring,
a plurality of tapered rollers interposed between the inner ring and the outer ring, and
a retainer which retains the plurality of tapered rollers, the retainer including: a small-diameter-side annular part, a large-diameter-side annular part, and pillar parts which are arranged at a plurality of positions in a circumferential direction and connect the small-diameter-side annular part and the large-diameter-side annular part,
wherein the following relational expression is satisfied by a small-diameter-side gap S1 which is a radial gap between the small-diameter-side annular part and the smaller collar part, a large-diameter-side gap S2 which is a radial gap between the large-diameter-side annular part and the larger collar part, an average roller diameter d of the tapered roller, a roller length 1, and an outer ring angle a which is a tapering angle at which a rolling surface of the outer ring is inclined:

$$1.06 < \frac{1}{tan α} ( 1 - \frac{Δ S}{{S}_{o}} \frac{d}{ℓ} ) < 1.64$$

where an equation, ΔS=S2−S1, is established, and S0 is a reference gap of 0.5 mm for a radial gap.

Units for S1, S2, d and 1 are mm, respectively.

The “inner ring guide form” refers to the small-diameter-side annular part being in opposition to or in contact with an outer peripheral surface of the smaller collar part of the inner ring through a limited radial gap and the large-diameter-side annular part being in opposition to or in contact with an outer peripheral surface of the larger collar part of the inner ring through a limited radial gap.

According to this configuration, with respect to the gaps defined between the radially outer parts of the inner ring collars and the radially inner parts of the retainer, the difference ΔS between the gaps on the side which is designed to guide the retainer and the side which is not designed to guide the retainer. Therefore, the bearing can be rotated with a smaller offset between the rotation axis of the retainer and the axis of the inner ring when centrifugal force acts. This makes it possible to reduce unbalanced whirling of the retainer and thereby to suppress wear of the retainer compared to a conventional tapered roller bearing. Reduction in unbalanced whirling of the retainer makes it possible to reduce axial movement of the retainer due to gyro moment and to cause the bearing to operate in a stable state.

In this configuration, the outer ring angle α may be more than 20° and less than 40°. A bearing having an outer ring angle α of 20° or less has small capacity to support axial load. A bearing having an outer ring angle α of 40° or greater has large capacity to support axial load, but has small capacity to support radial load. Since tapered roller bearings used in an environment where centrifugal force acts, such as a planetary reduction gear part, mainly support radial load, bearing products having a large outer ring angle α are rarely employed. In addition, bearing products having an outer ring angle α of 20° or less may not have sufficient capacity to support axial load, in a case where axial load is generated due to gear engagement in planetary reduction gears or the like.

The large-diameter-side annular part may include a flanged part extending in a bending manner toward a radially inside with respect to the pillar parts, and the flanged part may define a bending angle with respect to the pillar parts within a range of 90°±10°. The retainer has an appropriate shape as an inner ring-guided retainer when the bending angle of the flanged part falls within the range of 90°±10°.

The large-diameter-side annular part may include a flanged part extending in a bending manner toward a radially inside with respect to the pillar parts via a bent part having an arc shape, and the bent part may have a bent part R-dimension which is a radius of curvature on a radially inner surface of the bent part within a range of more than 20% and less than 90% relative to an axial length which is a length of the large-diameter-side annular part in a direction in which the pillar parts extend.

In this case, stress concentration can be suppressed and it is possible to prevent edges of end faces of the rollers from interfering with pocket opening edges during bending processing of the large-diameter-side annular part. In a case where the bent part R-dimension is 20% or lower relative to the axial length of the large-diameter-side annular part, greater stress concentration may occur during bending processing, possibly causing abnormalities to the retainer. On the other hand, in a case where the bent part R-dimension is 90% or higher, the radially inner surface of the bent part curves too gradually in arc shape, so that the edges of the end faces of the rollers could interfere with the pocket opening edges.

The small-diameter-side annular part and the large-diameter-side annular part may include flanged parts extending in a bending manner toward a radially inside with respect to the pillar parts, and the flanged parts may include oil passages defined therein which permit passage of lubricating oil inward and outward of the flanged parts in an axial direction of the bearing. Formation of the oil passages can facilitate passage of lubricating oil inward and outward of the flanged parts of the retainer, so that good lubrication can be achieved between rolling surfaces of the tapered rollers and pocket inner surfaces of the retainer.

The oil passages may be cutouts or through holes at a plurality of locations in a circumferential direction of the flanged parts. In this case, the oil passages which are the cutouts or the through holes can be easily formed at the flanged parts by machining or other means.

A ratio of a section area of the large-diameter-side annular part to a section area of the small-diameter-side annular part may fall within a range of from 1.0 to 1.2. In this case, the retainer can have appropriate weight balance between the large diameter side and the small diameter side, so that unbalanced whirling of the retainer can be reduced, and the retainer can be adequately guided by the inner ring.

The present invention encompasses any combination of at least two features disclosed in the claims and/or the specification and/or the drawings. In particular, any combination of two or more of the appended claims should be equally construed as included within the scope of the present invention.

### BRIEF DESCRIPTION OF THE DRAWINGS

The present disclosure will be more clearly understood from the following description of preferred embodiments made with reference to the accompanying drawings. However, the embodiments and the drawings are given merely for the purpose of illustration and explanation, and should not be used to delimit the scope of the present disclosure, which scope is to be delimited by the appended claims. In the accompanying drawings, alike numerals are assigned to and indicate alike or corresponding parts throughout the different figures, and:

FIG. 1 is a transverse cross-sectional view of a tapered roller bearing according to a first embodiment of the present invention;

FIG. 2 is a cross-sectional view of a retainer of the tapered roller bearing;

FIG. 3A is an end view showing a small-diameter-side end of the retainer;

FIG. 3B is an end view showing a large-diameter-side end of the retainer;

FIG. 4 is a partially enlarged cross-sectional view of the retainer;

FIG. 5 is a partially enlarged cross-sectional view showing a large-diameter-side annular part of the retainer and a tapered roller in a further enlarged manner;

FIG. 6 illustrates centrifugal force acting on a tapered roller bearing in a planetary reduction gear including the tapered roller bearing;

FIG. 7 illustrates a relationship between a parameter Xs and ΔS in the tapered roller bearing;

FIG. 8 is a cross-sectional view of a retainer of a tapered roller bearing according to a second embodiment of the present invention;

FIG. 9A is an end view showing a small-diameter-side end of the retainer;

FIG. 9B is an end view of showing a large-diameter-side end of the retainer;

FIG. 10 is a cross-sectional view showing an example of a planetary reduction gear including the tapered roller bearing according to any of the embodiments;

FIG. 11 shows a cross-sectional view taken along the line XI-XI in FIG. 10;

FIG. 12A shows a diagram that illustrates an example of a reference gap gauge used in gap control for the tapered roller bearing;

FIG. 12B shows a diagram that illustrates an example of a measurement gap gauge used in gap control for the tapered roller bearing; and

FIG. 13 illustrates a relationship between a parameter X and a guide gap S2 in a conventional tapered roller bearing.

### DESCRIPTION OF EMBODIMENTS

### First Embodiment

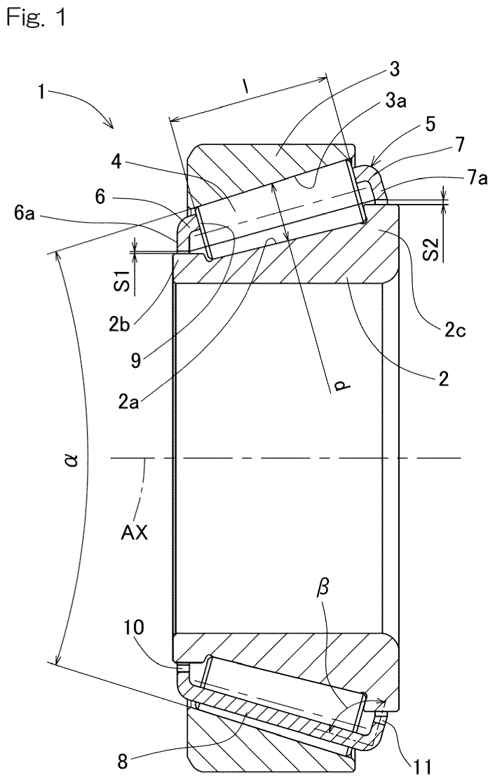

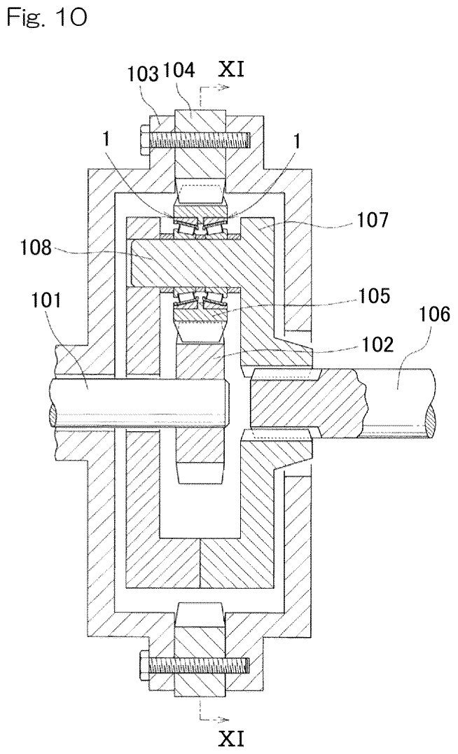

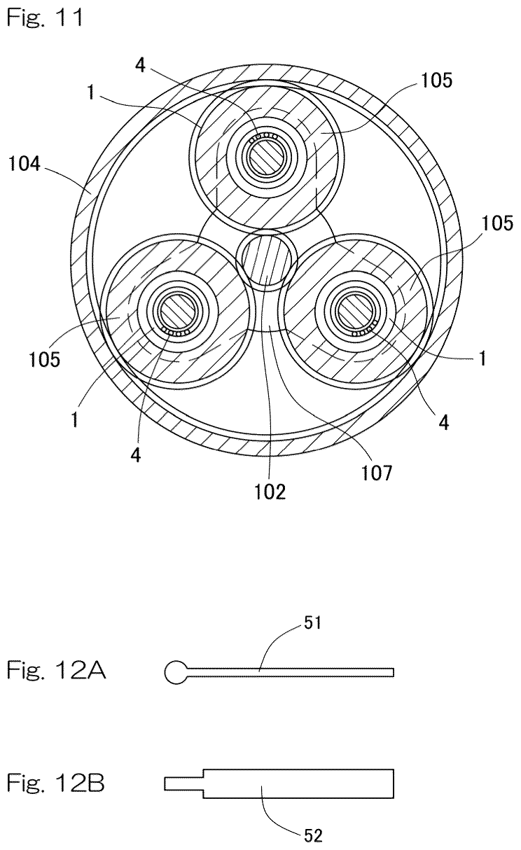

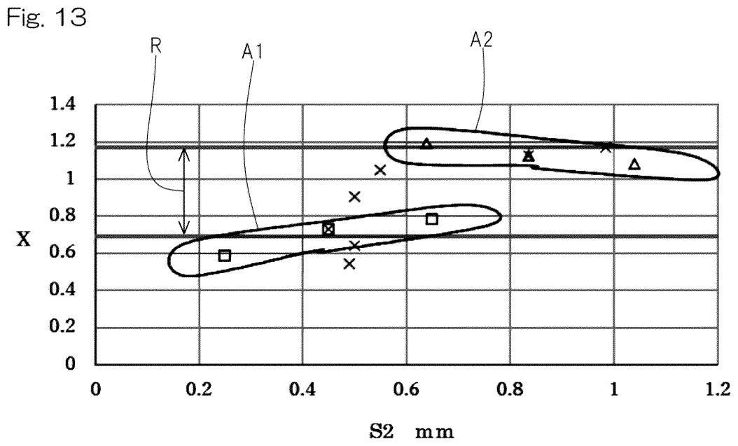

A tapered roller bearing in accordance with a first embodiment of the present invention will be described below in connection with FIGS. 1 to 7. It should be noted that this tapered roller bearing 1 is intended to be employed in a planetary part of a planetary speed reducer or planetary gear transmission which will be later discussed, for example, in connection with FIGS. 10 and 11.

Whole Structure of Tapered Roller Bearing As shown in FIG. 1, the tapered roller bearing 1 includes an inner ring 2, an outer ring 3, a plurality of tapered rollers 4 interposed between the inner ring 2 and the outer ring 3, and a retainer 5 retaining the plurality of tapered rollers 4.

The inner ring 2 has a tapered rolling surface 2a with an increasing diameter from one end to the other end of an outer peripheral surface of the inner ring 2 in the axial direction and has opposite collar parts including a smaller collar part 2b and a larger collar part 2c on the aforementioned one end and the other end, respectively. The outer ring 3 is in the form of an annular component having a tapered rolling surface 3a with an increasing diameter from one end to the other end of the outer ring 3 in opposition to the rolling surface 2a of the inner ring 2. While the outer ring 3 is shown with no collar parts in the illustrated embodiment, it may include a collar part protruding radially inwards from either one of the one end or the other end thereof.

In this specification, the tapered roller bearing is sometimes referred to simply as “bearing”. In the following description, a direction along a bearing center axis AX, which is a bearing axis, is referred to as “axial direction”, a direction perpendicular to the bearing center axis AX is referred to as “radial direction”, and a circumferential direction around the bearing center axis AX is referred as “circumferential direction”. Further, a side toward the bearing center axis AX is referred as an “inner diameter side” and a side away from the bearing center axis AX is refereed as an “outer diameter side”.

### Retainer

The retainer 5 includes a small-diameter-side annular part 6, a large-diameter-side annular part 7, and pillars 8 connecting the small-diameter-side annular part 6 and the large-diameter-side annular part 7 at more than one circumferential location. The pillars 8 adjacent in a circumferential direction define, therebetween, pockets 9 in which the tapered rollers 4 are retained. Inner diameter faces of the small-diameter-side annular part 6 and the large-diameter-side annular part 7 of the retainer 5 are respectively guided by the smaller collar part 2b and the larger collar part 2c of the inner ring 2. Thus, the tapered roller bearing 1 of this embodiment is that of an inner ring guide form. Herein, the “small-diameter-side annular part 6” refers to a part between an end edge on a small diameter side in the pocket 9 of the retainer 5 and an end face on a small diameter side of the retainer 5 with respect to an axial direction. In addition, the “large-diameter-side annular part 7” refers to a part between an end edge on a large diameter side in the pocket 9 of the retainer 5 and an end face on a large diameter side of the retainer 5 with respect to an axial direction.

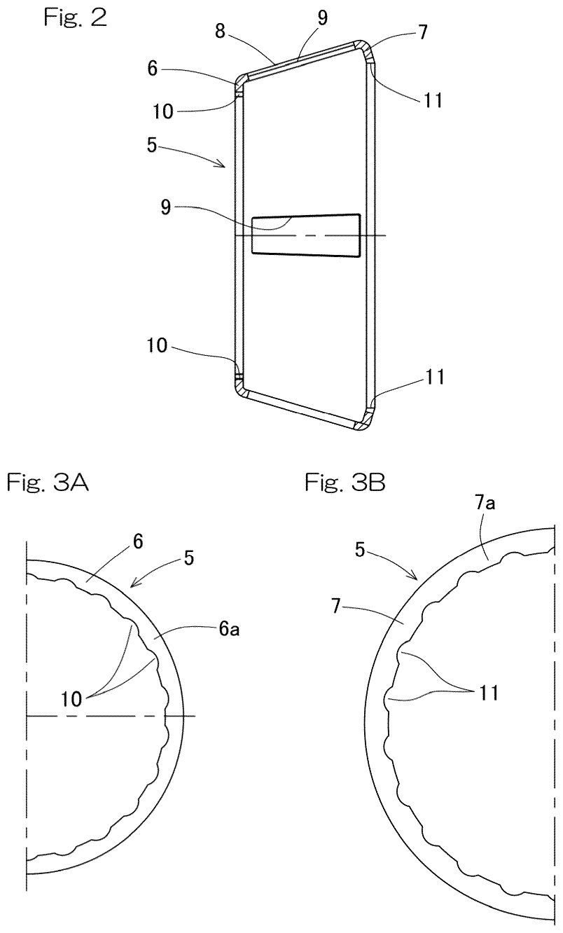

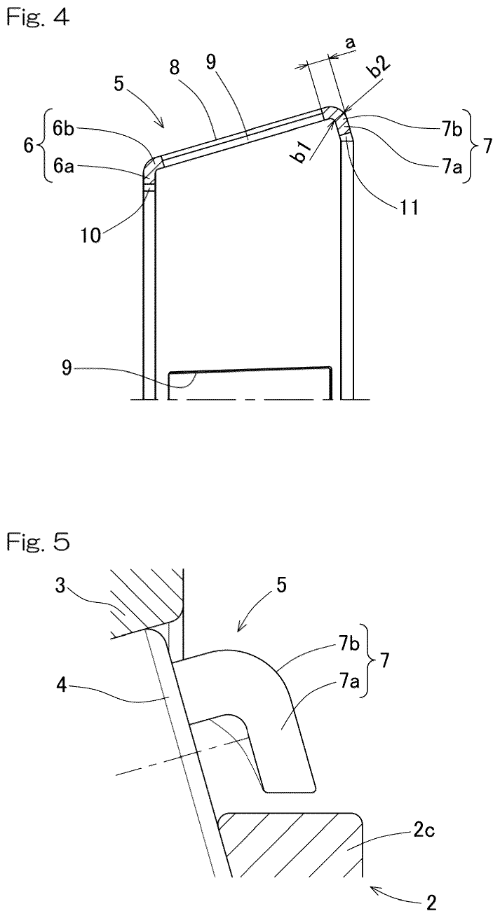

As shown in FIGS. 2 and 4, the small-diameter-side annular part 6 and the large-diameter-side annular part 7 include flanged parts 6a, 7a extending radially inwards via a bend from the pillars 8. In this embodiment, as shown in FIG. 1, the inner diameter faces of the small-diameter-side annular part 6 and the large-diameter-side annular part 7 extend parallel to outer peripheral surfaces of the smaller collar part 2b and the larger collar part 2c of the inner ring 2, respectively, while they may alternatively extend at an angle to the latter.

As shown in FIGS. 3A and 3B, the flanged parts 6a, 7a of the small-diameter-side annular part 6 and the large-diameter-side annular part 7 include, at a plurality of locations in the circumferential direction, oil passages 10, 11 defined therein which permit passage of lubricating oil inward and outward of the flanged parts 6a, 7a in the axial direction of the bearing. In this embodiment, the oil passages 10, 11 have the form of cutouts at an inner peripheral edge of the flanged parts 6a, 7a. Specifically, the oil passages 10, 11 are arc-shaped cutouts recessed outward in a radial direction from the inner peripheral edge of the flanged parts 6a, 7a. Nevertheless, the oil passages 10, 11 may be omitted.

### Manufacturing Method for Retainer

As shown in FIG. 2, the retainer 5 is a press retainer made from a metal plate such as a steel plate in this embodiment, and the small-diameter-side annular part 6 and the large-diameter-side annular part 7 are formed by bending processing. The pillars 8 are formed by pressing to punch out the pockets 9. As shown in FIGS. 3A and 3B, the oil passages 10, 11 having the form of cutouts are formed in each inner circumferential side of the small-diameter-side annular part 6 and the large-diameter-side annular part 7 by machine processing such as pressing or another processing at equal intervals in the circumferential direction. The material of the retainer 5 is not limited to metal, but it can be resin, for example.

### Parameter

A parameter Xs as a dimensionless number is determined by the following formula defined by a small-diameter-side gap S1, a large-diameter-side gap S2, an average roller diameter d of the rollers 4, a roller length 1 of the rollers 4 and an outer ring angle α.

$${X}_{s} = \frac{1}{tan α} ( 1 - \frac{Δ S}{{S}_{o}} \frac{d}{ℓ} )$$

Herein, an equation, ΔS=S2−S1, is established, and S0 is a reference gap of 0.5 mm for a radial gap.

The small-diameter-side radial gap S1 is a gap between the small-diameter-side annular part 6 of the retainer 5 and the smaller collar part 2b of the inner ring 2. The large-diameter-side gap S2 is a radial gap between the large-diameter-side annular part 7 and the larger collar part 2c of the inner ring 2. The average roller diameter d is a roller diameter at an axial intermediate portion of the tapered roller 4. The outer ring angle α is a tapering angle at which the rolling surface 3a of the outer ring 3 is inclined, i.e., an angle defined by two linear lines representing the opposite rolling surfaces 3a in a section along a plane including the bearing axis AX of the outer ring 3.

The thus-determined parameter Xs falls within the range of 1.06<Xs<1.64. In this regard, in the tapered roller bearing 1 of this embodiment, the outer ring angle α preferably falls within the range of from 20° to 40°.

The flanged part 7a of the large-diameter-side annular part 7 defines a bending angle ⊖ with respect to the pillar parts 8 within the range of 90°±10°. In other words, in the cross-sectional shape of FIG. 1, the angle β defined by the directions in which the pillar parts 8 and the flanged part 7a extend is within the range of 90°±10°. In this embodiment, the inner diameter faces of the small-diameter-side annular part 6 and the large-diameter-side annular part 7 extend parallel to the outer peripheral surfaces of the smaller collar part 2b and the larger collar part 2c of the inner ring 2, while they may alternatively extend at an angle to the latter.

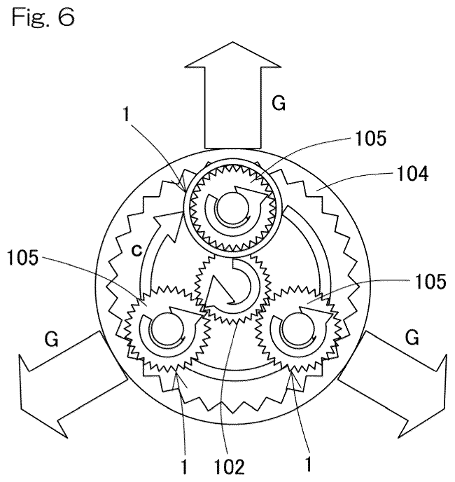

As shown in FIGS. 4 and 5 in an enlarged manner, more specifically, the flanged part 7a of the large-diameter-side annular part 7 of the retainer 5 is bent toward the radially inside with respect to the pillar parts 8 via a bent part 7b having an arc shape. Namely, the pillar parts 8 and the flanged part 7a are coupled via the bent part 7b having an arc shape. In this embodiment, a bent part R-dimension b1 which is the radius of curvature on the radially inner surface of the bent part 7b is set to more than 20% and less than 90% (0.2a<b1<0.9a) with respect to an axial length a which is the length of the large-diameter-side annular part 7 in the direction in which the pillar parts 8 extend. A bent part R-dimension b2 on the radially outer surface of the bent part 7b is not limited specifically.

As shown in FIG. 4, the ratio of the section area of the large-diameter-side annular part 7 of the retainer 5 to the section area of the small-diameter-side annular part 6 falls within the range of from 1.0 to 1.2. As used herein, the ratio of the section areas is calculated based on section areas at circumferential locations where the oil passages 10, 11 are not located. The cross section is a transverse cross section in which the retainer 5 is cut along a plane including the axial direction.

### Effects of the Above Features

As shown in FIG. 6, the tapered roller bearing 1 is subjected to centrifugal force G when the tapered roller bearing is used in a revolving environment (as indicated by arrow c), such as a planetary part of a planetary reduction gear, and force acts on the retainer 5 shown in FIG. 1 due to the centrifugal force to cause the retainer to be tilted. In order to appropriately maintain the inclination of the retainer 5 during operation, use of an inner ring-guided retainer 5 alone is not sufficient. It is necessary to appropriately control the gaps between the rollers 4 and the retainer 5 during operation (i.e., radial gap and axial gap), in addition to the difference ΔS between the small-diameter-side gap S1 and the large-diameter-side gap S2 during standstill. The gaps between the rollers 4 and the retainer 5 during operation are defined by the average roller diameter d and the roller length 1.

With this in mind, the parameter Xs which is determined on the basis of the average roller diameter d and the roller length I was conceived in relation to the difference ΔS between the small-diameter-side gap S1 and the large-diameter-side gap S2, and the inventors of the present application find that tilting of the rotation axis of the retainer can be suppressed if the parameter Xs is within an appropriate range. This finding was confirmed by test and analysis. As a consequence, it was found that tilting of the rotation axis of the retainer 5 can be suppressed by controlling the difference ΔS between the small-diameter-side gap S1 and the large-diameter-side gap S2 such that the parameter Xs falls within the range of 1.06<Xs<1.64.

### Endurance Test

The test and analysis were carried out to find out if samples can withstand centrifugal force of 30 G or greater for a testing time of 1300 hr, in imitation of a planetary part of a planetary reduction gear. All the tapered roller bearings 1 in the test and analysis had the following dimensions: inner diameter 76×outer diameter 136.5×width 46.0 (unit: mm), and the outer ring angle α is within a range of from 20° to 40° (e.g., α=35°). The dimensions (average roller diameter, roller length, small-diameter-side gap S1, large-diameter-side gap S2) of different parts of the tapered roller bearings 1 in the test and analysis were set to such that the parameter Xs had the values shown in Table 1, although these dimensions are omitted in the table. The condition of the retainer in FIG. 1 was visually recognized.

TABLE 1
Results of Endurance Test

| Sample No. | (1) | (2) | (3) | (4) | (5) | (6) | (7) | (8) |
|---|---|---|---|---|---|---|---|---|
| Xs | 0.59 | 0.91 | 1.06 | 1.22 | 1.43 | 1.59 | 1.64 | 1.69 |
| Condition of | Poor | Poor | Good | Good | Good | Good | Good | Poor |
| Retainer | | | | | | | | |

Good: no wear, Poor: severe wear (not continuously usable)
α is within a range of from 20° to 40°.

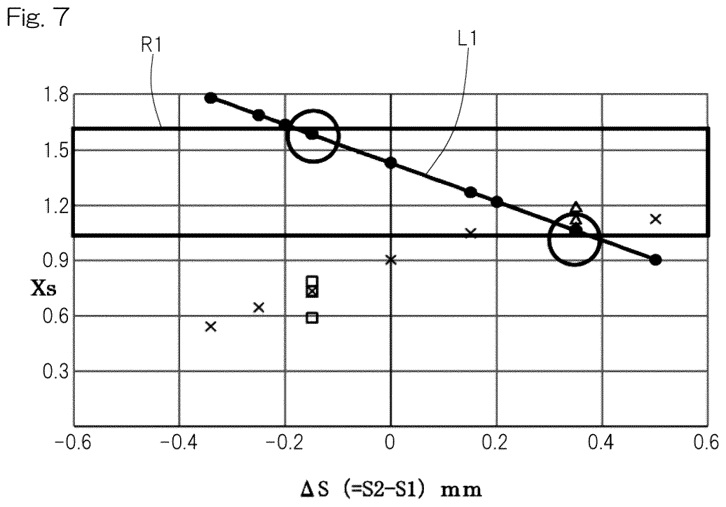

As shown in Table 1 and FIG. 7, according to the results of the endurance test, favorable results of no wear in the retainer were obtained in the range R1 of 1.06<Xs<1.64, in which Samples (3) to (7) are included. In FIG. 7, cross marks represent a simulation example showing the relationship between the parameter Xs and ΔS when ΔS is not fixed. Square marks represent the relationship between the parameter Xs and ΔS when the absolute value of ΔS is fixed to 0.15 mm. Triangle marks represent the relationship between the parameter Xs and ΔS when the absolute value of ΔS is fixed to 0.35 mm. Black circles represent the relationship between the parameter Xs and ΔS when S1 and S2 are varied. A linear line L1 in FIG. 7 is a theoretical value of the parameter Xs. Even if S1 and S2 are varied, the parameter Xs remains within the range R1.

### Functions and Effects

According to the tapered roller bearings 1 in Fig, 1 described above, the difference ΔS is reduced between the gaps on the side which is designed to guide the retainer and the side which is not designed to guide the retainer, with respect to the gaps defined between the radially outer parts of the inner ring collars and the radially inner parts of the retainer. Namely, by satisfying the relation 1.06<Xs<1.64, the bearing can be rotated with a smaller offset between the rotation axis of the retainer 5 and the axis of the inner ring 2 when centrifugal force acts.

This makes it possible to reduce unbalanced whirling of the retainer and thereby to suppress wear of the retainer 5 compared to a conventional tapered roller bearing. Reduction in unbalanced whirling of the retainer 5 makes it possible to reduce axial movement of the retainer 5 due to gyro moment and to cause the bearing to operate in a stable state.

The outer ring angle α is preferably more than 20° and less than 40°. A bearing having an outer ring angle a of 20° or less has small capacity to support axial load. A bearing having an outer ring angle α of 40° or greater has large capacity to support axial load, but has small capacity to support radial load. Since tapered roller bearings used in an environment where centrifugal force acts, such as a planetary reduction gear part, mainly support radial load, bearing products having a large outer ring angle a are rarely employed. In addition, bearing products having an outer ring angle α of 20° or less may not have sufficient capacity to support axial load, in a case where axial load is generated due to gear engagement in planetary reduction gears or the like.

In the retainer 5, the bending angle β of the flanged part 7a of the large-diameter-side annular part 7 (a bending angle of the flanged part 7a relative to the pillar parts 8) falls within the range of 90°±10° with reference to the retainer angle. For this reason, the retainer 5 can have an appropriate shape as an inner ring-guided retainer.

As shown in FIG. 4, since the bent part 7b of the large-diameter-side annular part 7 of the retainer 5 has the bent part R-dimension b1 on the radially inner surface within the range of more than 20% and less than 90% relative to the axial length a of the large-diameter-side annular part 7, the following issues do not That is, in a case where the bent part R-dimension b1 is 20% or lower occur. relative to the axial length a of the large-diameter-side annular part 7, greater stress concentration may occur during bending processing, possibly causing abnormalities to the retainer 5. On the other hand, in a case where the bent part R-dimension is 90% or higher, the radially inner surface of the bent part 7b curves too gradually in arc shape as indicated in FIG. 5, so that the edges of the end faces of the rollers 4 could interfere with the opening edges of the pockets 9. Such a problem can be eliminated by setting the dimension within the range of more than 20% and less than 90%.

As shown in FIGS. 3A and 3B, the flanged parts 6a, 7a of the small-diameter-side annular part 6 and the large-diameter-side annular part 7 of the retainer 5 include oil passages 10, 11 in the form of cutouts at a plurality of locations in the circumferential direction. Formation of the oil passages 10, 11 can facilitate passage of lubricating oil inward and outward of the flanged parts 6a, 7a of the retainer 5. Therefore, good lubrication can be achieved between the rolling surfaces of the tapered rollers 4 and the pocket inner surfaces of the retainer 5.

As shown in FIG. 2, the ratio of the section area of the large-diameter-side annular part 7 of the retainer 5 to the section area of the small-diameter-side annular part 6 falls within the range of from 1.0 to 1.2. In a case where the ratio of the section areas falls within the range of from 1.0 to 1.2, the retainer can have appropriate weight balance between the large diameter side and the small diameter side, so that unbalanced whirling of the retainer 5 can be reduced, and the retainer can be adequately guided by the inner ring.

### Other Embodiments

In the following description, parts corresponding to the matters described in the preceding embodiment are designated by the same reference numerals, and the redundant description thereof is omitted. When only a part of a configuration is described, the remaining part of the configuration is the same as that described in the preceding embodiment, unless otherwise specified. The same advantageous effects are achieved by the same configuration. A combination of parts that are specifically described in respective embodiments can be implemented, and, further, embodiments may be partially combined unless such combination causes any problem.

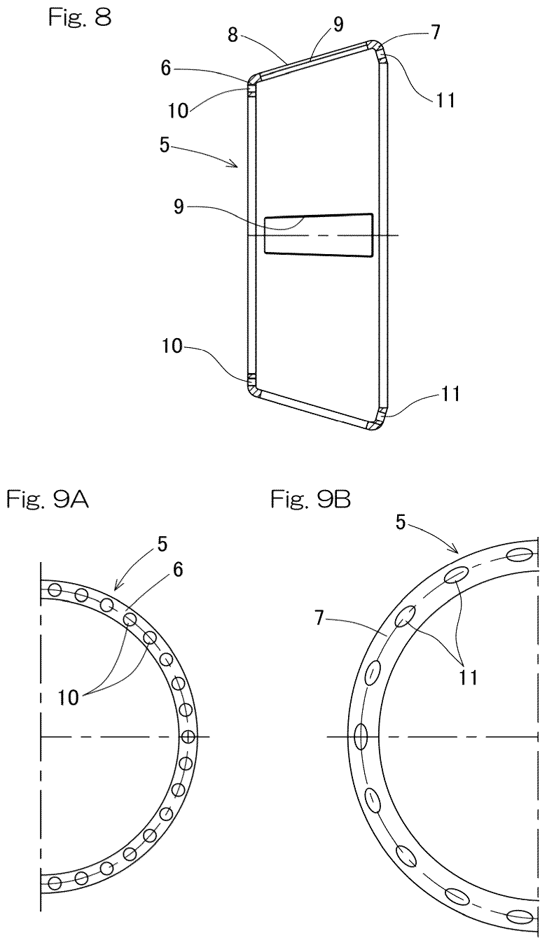

### Second Embodiment: FIGS. 8-9B

As shown in FIG. 8, FIG. 9A and FIG. 9B, the oil passages 10, 11 may be through holes which pass through the flanged part 6a, 7a in the axial direction. The flanged part 6a of the small-diameter-side annular part 6 has round oil passages 10 which is the through holes, and the flanged part 7a of the large-diameter-side annular part 7 has oblong oil passages 11 which is the through holes. Formation of the oil passages 10, 11 can facilitate passage of lubricating oil inward and outward of the flanged parts 6a, 7a of the retainer 5. Therefore, good lubrication can be achieved between the rolling surfaces of the tapered rollers and the pocket inner surfaces of the retainer 5. The same functions and effects as in the first embodiment are achieved.

### Application Example of Tapered Roller Bearing

FIG. 10 and FIG. 11 show one example of a planetary reduction gear in which the tapered roller bearing 1 according to any of the embodiments is used. This planetary reduction gear includes a plurality of planetary rotating bodies 105 as planetary gears which engage with a sun gear 102 attached to an input shaft 101 and an internal gear 104 fixed to a housing 103, between these gears 102, 104. Each planetary rotating body 105 is supported in a rotatable manner with respect to a carrier 107 coupled to an output shaft 106, and revolutionary motion of this planetary rotating body 105 which revolves while rotating between the sun gear 102 and the inner gear 104 is outputted to the output shaft 106 through the carrier 107. The planetary reduction gears, for example, serve to reduce the speed of rotation in a first stage of a final reduction gear disposed inside a wheel rim of a construction machine.

A pair of tapered roller bearings 1 are arranged between the planetary rotating body 105 and the carrier 107 of the planetary reduction gear. The respective outer rings 3 (FIG. 1) of the tapered roller bearings 1 are attached to the planetary rotating body 105 and rotate together with the planetary rotating body 105. The respective inner rings 2 (FIG. 1) of the tapered roller bearings 1 are attached in a fixed manner to a support shaft 108 of the carrier 107.

It should be noted that the small-diameter-side gap S1 and the large-diameter-side gap S2 change depending on, e.g., insufficient swaging of the small-diameter-side annular part 6 of the retainer 5 during assembling. For this reason, the small-diameter-side gap S1 is measured, for example, in a following manner. A reference gap gauge 51 shown in FIG. 12A is inserted between the radially inner part of the retainer and the radially outer part of the inner ring collar at positions with a 180°-phase difference to measure the small-diameter-side gap S1 at the 0°-phase and at the 180°-phase. An average of the measurements is taken as a reference gap. Then, the reference gap gauge 51 is inserted into the small-diameter-side gap S1 to obtain the reference gap (the above-described average) at one position. In this state, a measurement gap gauge 52 shown in FIG. 12B is inserted at the position separated by 180°-phase therefrom to measure the small-diameter-side gap S1 and determine if the measured value is within the appropriate range.

The present disclosure is not limited to the foregoing embodiments, and various additions, changes, or omissions can be made therein without departing from the principle of the present disclosure. For example, the oil passages 10, 11 shown in FIGS. 3A and 3B are not limited to arc-shaped cutouts, but may be formed in a concave-convex shape inward and outward in the radial direction. The oil passages 10, 11 of FIGS. 3A and 3B or FIGS. 9A and 9B may be arranged at unequal intervals in the circumferential direction.

In addition, depending on loading conditions, the outer ring angle α in FIG. 1 may be less than 20° and more than 40°. The retainer 5 may be manufactured by a 3D printer. The tapered roller bearings 1 can be used for variety of applications other than the planetary reduction gear. Accordingly, such variants are also encompassed within the scope of the present disclosure.

### REFERENCE NUMERALS

1 . . . tapered roller bearing
2 . . . inner ring
2a. . . rolling surface
2b. . . smaller collar part
2c. . . larger collar part
3 outer member
3a. . . rolling surface
4 . . . tapered roller
5 . . . retainer
6 . . . small-diameter-side annular part
6a. . . flanged part
7 . . . large-diameter-side annular part
7a. . . flanged part
7b. . . bent part
8 . . . pillar part
10, 11 . . . oil passage
S1 . . . small-diameter-side gap
S2 . . . large-diameter-side gap
d . . . average roller diameter
1 . . . roller length
αa . . . outer ring angle

What is claimed is:

1. A tapered roller bearing of an inner ring guide form comprising:
an inner ring including a smaller collar part and a larger collar part,
an outer ring,
a plurality of tapered rollers interposed between the inner ring and the outer ring, and
a retainer which retains the plurality of tapered rollers, the retainer including: a small-diameter-side annular part, a large-diameter-side annular part, and pillar parts which are arranged at a plurality of positions in a circumferential direction and connect the small-diameter-side annular part and the large-diameter-side annular part,
wherein the following relational expression is satisfied by a small-diameter-side gap S1 which is a radial gap between the small-diameter-side annular part and the smaller collar part, a large-diameter-side gap S2 which is a radial gap between the large-diameter-side annular part and the larger collar part, an average roller diameter d of the tapered roller, a roller length 1, and an outer ring angle a which is a tapering angle at which a rolling surface of the outer ring is inclined:
$$1.06 < \frac{1}{tan α} ( 1 - \frac{Δ S}{{S}_{o}} \frac{d}{ℓ} ) < 1.64$$
where equations, ΔS=S2−S1 and S0=0.5 (fixed values), are established.

2. The tapered roller bearing as claimed in claim 1, wherein
the large-diameter-side annular part includes a flanged part extending in a bending manner toward a radially inside with respect to the pillar parts, and
the flanged part defines a bending angle with respect to the pillar parts within a range of 90°±10°.

3. The tapered roller bearing as claimed in claim 1, wherein
the large-diameter-side annular part includes a flanged part extending in a bending manner toward a radially inside with respect to the pillar parts via a bent part having an arc shape, and
the bent part has a bent part R-dimension which is a radius of curvature on a radially inner surface of the bent part within a range of more than 20% and less than 90% relative to an axial length which is a length of the large-diameter-side annular part in a direction in which the pillar parts extend.

4. The tapered roller bearing as claimed in claim 1, wherein
the small-diameter-side annular part and the large-diameter-side annular part include flanged parts extending in a bending manner toward the radially inside with respect to the pillar parts, and
the flanged parts include oil passages defined therein which permit passage of lubricating oil inward and outward of the flanged parts in an axial direction of the bearing.

5. The tapered roller bearing as claimed in claim 4, wherein the oil passages are cutouts or through holes at a plurality of locations in a circumferential direction of the flanged parts.

6. The tapered roller bearing as claimed in claim 1, wherein a ratio of a section area of the large-diameter-side annular part to a section area of the small-diameter-side annular part falls within a range of from 1.0 to 1.2.
